(19) United States
(12) Patent Application Publication
(10) Pub. No.: US 2018/0300745 A1
(43) Pub. Date: Oct. 18, 2018

(54) Advertising

(71) Applicants: David Aubespin, New York, NY (US); Arnaud Sahuguet, New York, NY (US)

(72) Inventors: David Aubespin, New York, NY (US); Arnaud Sahuguet, New York, NY (US)

(73) Assignee: GOOGLE INC., Mountain View, CA (US)

(21) Appl. No.: 11/839,902

(22) Filed: Aug. 16, 2007

(51) Int. Cl. G06Q 30/02

(52) U.S. Cl. CPC G06Q 30/0241

(57) ABSTRACT

Identifying an advertisement template including a placeholder; identifying rules for creating or identifying content for the placeholder; using the rules and the advertisement template, determining content for the placeholder; and, using the content, creating an advertisement.

### TECHNICAL FIELD

This disclosure relates to advertising.

### BACKGROUND

Advertising is one way to bring information to the attention of a target audience. Often, the information relates to a product or service that the advertiser seeks to sell or promote to the target audience. An advertiser may sometimes desire to change its advertisements over time, and in some instances rapidly, relative to the time it would take to create new advertisements. For example, in some markets, the price of a product may fluctuate daily, or faster. One way to advertise in such markets is to include only a price range, but not a specific price, in an advertisement.

Additionally, some advertisers may desire their advertisements to change at a time that is difficult or cumbersome to ascertain in advance. For example, a company may wish to offer the first 1,000 units of its inventory at a discounted sale price, and offer the rest of the inventory without the discount. An advertiser implementing this approach may want to advertise the discounted price until the first 1,000 units are sold, and then subsequently advertise the regular price.

Since it may not be clear a priori when the first 1,000 units will sell, one conventional strategy involves the advertiser manually monitoring the inventory, and then manually updating the advertising campaign when the first 1,000 units are sold. This strategy may be cumbersome, insofar as it calls for frequent monitoring of inventory. Another conventional strategy involves estimating when the first 1,000 units will sell, and scheduling a change of advertising based on the estimate. There may be a risk of inaccurate advertising if the estimate is inaccurate.

### SUMMARY

In general, in an aspect, an advertisement template is identified that includes a placeholder. Rules are identified for creating or identifying content for the placeholder. The rules and the advertisement template are used to determine content for the placeholder, and the content is used to create an advertisement.

Implementations may have one or more of the following features. The advertisement template includes a creative template corresponding to a portion of the advertisement that is directly perceivable by a viewer. The advertisement template includes a keyword template corresponding to one or more keywords of the advertisement for use when comparing the advertisement to other content. Also identifying data, wherein the rules express a condition on the data. The advertisement describes a product, and the data is related to the product. The advertisement describes a product, the data relates to the supply of, or demand for, the product, and the rules express a condition on the data related to the supply of, or demand for, the product. The condition includes falling inside a specified numerical range. The data includes a calendar of events, and the condition includes the occurrence of an event on the calendar. The data includes data related to the context in which the advertisement is displayed, and the rules include a condition related to the context in which the advertisement is displayed. The advertisement describes a product, and the data is unrelated to the product. The data includes a price of a product described in the advertisement, and the content for the placeholder is determined by also using the price. The placeholder includes a first placeholder, and the rules include a rule for identifying content for a second placeholder based on the content for the first placeholder. The advertisement includes one or more keywords determined from the keyword template, each of the keywords having a match type. Each match type is selected from the group consisting of: specific, general, phrase, and negative. A first keyword has a first match type, and a second keyword has a second match type, the first keyword being distinct from the second keyword, and the first match type being distinct from the second match type. Also identifying a maximum advertising cost associated with each keyword. Also identifying a set of blacklisted terms, and determining whether the content includes a term in the set of blacklisted terms.

In general, in an aspect, a system includes a first data store including an advertisement template; a second data store including advertisement generation rules, a third data store including advertisement data; and a rules processing engine operable to create an advertisement based on the advertisement template, the advertisement generation rules, and the advertisement data.

Implementations may have one or more of the following features. The advertisement template includes a creative template corresponding to a portion of the advertisement that is directly perceivable by a viewer. The advertisement template includes a keyword template corresponding to one or more keywords of the advertisement for use when comparing the advertisement to other content. The system also includes a fourth data store including external data, and the rules processing engine is operable to create the advertisement based further on the external data. The external data includes product data relevant to a product described in the advertisement. The external data includes context data relevant to a context in which the advertisement is served.

Particular implementations may include one or more of the following advantages: advertisements can be automatically generated or changed based on conditions (e.g., conditions related to supply or demand of an advertised product, the occurrence or non-occurrence of a particular event, etc.) The conditions can be user defined and specified with a relatively great amount of flexibility.

Other aspects include other combinations of the features recited above and other features, expressed as methods, apparatus, systems, program products, and in other ways. Other features and advantages will be apparent from the description and from the claims.

### DESCRIPTION OF DRAWINGS

FIG. 1 is a schematic representation of an exemplary advertisement system.

FIG. 2A is a schematic depiction of an exemplary advertisement template.

FIG. 2B is a schematic depiction of an exemplary advertisement template.

FIGS. 2C and 2D are exemplary advertisements that have been created using the exemplary advertisement template of FIG. 2B.

FIG. 3 is a schematic view of an exemplary advertisement creation engine.

FIG. 4 is a flowchart for creating an advertisement.

FIGS. 5A-F show exemplary screenshots for a user using the advertisement system.

FIG. 6 is a block diagram of a exemplary computing device that may be used to implement an advertisement system, as either a client or as a server or plurality of servers.

Like reference symbols in the various drawings indicate like elements.

### DETAILED DESCRIPTION

In some implementations, an advertisement system is provided that allows, among other things, an advertiser to implement an advertising campaign by specifying (implicitly or explicitly) various advertisement criteria using, for example, templates. The templates in turn are used to automatically create advertisements in accordance with detected events and the advertisement criteria.

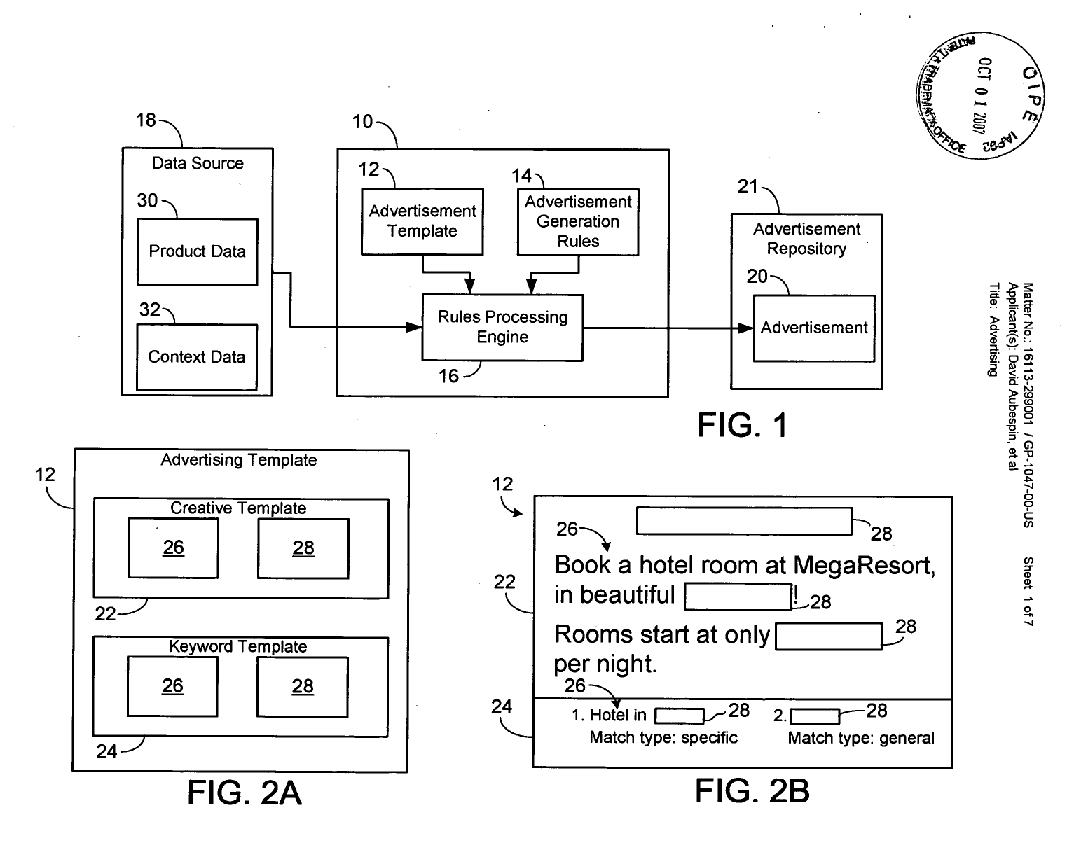

FIG. 1 is a schematic representation of an example advertisement system 10. By way of example, the advertisement system 10 includes tools for adjusting the selection of an advertisement in accordance with various criteria. The criteria and an advertisement (i.e., creative) definition can be instantiated using one or more templates. As shown, the advertisement system 10 includes one or more (e.g., several) advertisement templates 12, one or more (e.g., several) advertisement generation rules 14, and a rules processing engine 16. The advertisement system 10 may be in data communication with one or more (e.g., several) data sources 18. As described more fully below, the rules processing engine 16 uses the advertisement generation rules 14 and data from the data source 18 (including, e.g., product data 30 or context data 32) to create an advertisement 20 from the advertisement template 12.

In some implementations, the data source 18 includes one or more data streams in data communication with the rules processing engine 16. For example, the data source 18 may include a product data source 30 that provides data related to supply, demand, pricing, or other information about the advertised product or service etc. In some implementations, the product data source 30 is populated with data using a feed from a manufacturer's or proprietor's computer system, a point of sale system, an inventory system, or the like.

Furthermore, the data source 18 may also include, or be associated with, a context data source 32 that provides data related to the context in which the product or service can be used, or the context in which the advertisement 20 appears before the target audience. In some implementations, the context data source 32 can include any type of information, for example, a weather forecast in one or more geographic locations, information from one or more securities markets, one or more calendars of events, results of one or more political or consumer polls, view rates of particular media (e.g. electronic media), etc. In some implementations, the context data source 32 can be populated by one or more data feeds from a system used to provide the desired data.

The advertisement 20 may be stored on one or more (e.g., several) advertisement repositories 21, along with other advertisements 20. In some implementations, the advertisement repository 21 can be in data communication with one or more (e.g., several) advertisement servers (not shown) that serve the advertisements 20 to clients. Advertisement servers can serve advertisements 20 in a variety of contexts. For example, an advertisement server can serve advertisements 20 based on: a client's submitted search query to a search engine, the content of a web page being served to the client, etc.

There is no requirement that the advertisement template 12, the advertisement generation rules 14, or the rules processing engine 16 all reside on the same data storage medium, on the same computer system, or same electrical device or in the same geographic location. For example, the advertisement template 12 may reside on an advertiser's computer network, the advertisement generation rules may reside on a manufacturer's computer network, and the rules processing engine may be distributed over several computers in an advertising network. The advertisement template 12 may include several distinct files that are stored on several distinct storage media. Moreover, various parties may access the advertisement template 12, the advertisement generation rules 14, or the rules processing engine 16 remotely, regardless of where the advertisement template 12, the advertisement generation rules 14, or the rules processing engine 16 reside.

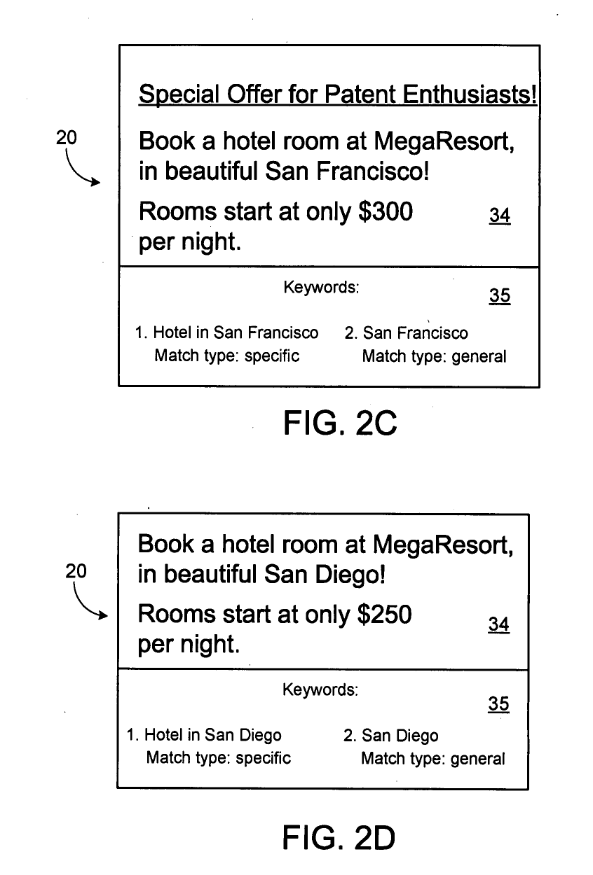

FIG. 2A is a schematic depiction of an exemplary advertisement template 12. The advertisement template 12 includes a creative template 22 and a keyword template 24. In some implementations, each template 22-24 may include a fixed component 26 and may include one or more placeholders 28. In some examples, one or both templates 22, 24 do not include a fixed component 26 or any placeholders 28. Content need not be specified for each placeholder 28 in order to create an advertisement 20. That is, content need not be explicitly defined by the user at the time of creation of the templates 22-24. Content can be dynamically specified in accordance with context information, events or other data at a time for display.

The creative template 22 is used to form the creative content 34 (see FIG. 2C), which is the portion of the advertisement 20 that is directly perceived by the target audience. In general, the creative template 22 can utilize any medium of expression. For example, the creative template 22 can use textual, graphic, audio, video, or tactile, or olfactory content, or any combination of these in its fixed component 26 or its placeholders 28.

The keyword template 24 is used to generate keywords 35 (see FIG. 2C) that describe, relate to, are otherwise to be associated with the advertisement 20. In some implementations, the key words or phrases can be used to place the advertisement 20 in other media, or determine whether to present the advertisement 20 to a member of the target audience. For example, if one of the key words or phrases is similar to other words or phrases in another document such as a web page, then the advertisement 20 may be placed in the other document.

Optionally, a match type (e.g., “general,” “specific,” “exact,” or “negative”) may also be used in the keyword template 24. The match type can be used, for example, to determine criteria by which to serve the advertisement 20.

In one implementation, a word or phrase designated as a “specific” match may be used to indicate that the advertisement 20 may be served only in response to that precise word or phrase appearing in a document or query. Thus, if the keyword “tennis shoes” is designated as having a specific match type, then the advertisement 20 will not be displayed to a user who supplies the query “shoes for tennis,” but will be displayed to a user who supplies the query “discount tennis shoes,” based on this keyword 35.

In one implementation, a word or phrase designated as an “exact” match may be used to indicate that the advertisement 20 may be served only when that precise word or phrase—and no other words or phrases—appears in the document or query. For example, if the keyword “tennis shoes” is designated as having an exact match type, then the advertisement 20 will not be displayed to a user who supplies the query “discount tennis shoes.”

In one implementation, a negative keyword is a word or phrase to which the advertisement 20 is meant to be not responsive (i.e., not served). For example, if “jury duty” is a negative keyword 35 associated with an advertisement 20, then the advertisement 20 will not be served in response to queries or documents containing the phrase “jury duty.”

FIG. 2B is a schematic depiction of an exemplary advertisement template 12. The fixed component 26 of the creative template 22 includes text inviting the reader to book a hotel visit. The placeholders 28 in the creative template include a space for a heading, a space for a city, and a space for a price. The fixed component 26 of the keyword template 24 includes the phrase “hotel in.” The placeholders 28 of the keyword template 24 include a space after “hotel in” for a city, and a separate space for the city. The phrase “hotel in [city]” is designated a specific match, while “[city]” alone is designated as a general match.

FIGS. 2C and 2D show exemplary advertisements 20 that have been created using the exemplary advertisement template 12 of FIG. 2B. Each advertisement 20 includes creative content 34 and keywords 35. The creative content 34 is obtained from the creative template 22 by filling in placeholders 28. Similarly, the keywords 35 are obtained from the keyword template 24 by filling in placeholders 28.

Each advertisement 20 in FIGS. 2C and 2D lists a different city (San Francisco/San Diego) and a different price ($300/$250). Note that the advertisement 20 of FIG. 2C contains a heading (“Special Offer for Patent Enthusiasts!”), where the advertisement 20 of FIG. 2D contains no heading.

Referring back to FIG. 1, the advertisement generation rules 14 include rules indicating how content for the placeholders 28 in an advertisement template 12 is to be determined. One set of advertisement generation rules 14 can be used to generate content for placeholders 28 in one or more advertisement templates 12. Conversely, one or more sets of advertisement generation rules 14 can be used to generate content for placeholders 28 in a single advertisement template 12. The advertisement generation rules 14 may include any algorithm or logically consistent set of instructions for unambiguously determining an advertisement template 12 and content for its placeholders 28. In some implementations, the advertisement generation rules 14 include a series of absolute statements (e.g., “do . . . ”) or conditional statements (e.g., “if . . . , then do . . . ”) that refer to certain placeholders 28 and information related to or retrieved from the data source 18. The advertisement generation rules 14 may also include recursive rules. For example, the rules 14 may be used to determine content of one placeholder 28 based on the content of another placeholder 28. In some implementations, the rules 14 are expressed in a programming language, for example C, C++, Java, etc. In some implementations, conditional statements used in the rules 14 include whether the value of a specified variable falls within a numerical range, in which the specified variable corresponds to a datum in the data source 18. For example, the datum in the data source 18 can relate to the supply of, or demand for, a product described in the advertisement.

In some implementations, the advertisement generation rules 14 refer to data related to a product described in the advertisement 20. For example, suppose an advertiser has created an advertisement template 12 with a single placeholder 28 for the price of a particular item. If the advertiser wishes to advertise a sale price until 1,000 units are sold, the advertisement generation rules 14 may include a conditional statement equivalent to “if the number of units sold is less than or equal to 1,000, use the sale price. Otherwise, use the regular price.”

In some implementations, the advertisement generation rules 14 refer to or evaluate data other than data related to the product/service described in the advertisement 20. For example, in an advertising template 12 for a California hotel chain in which one placeholder 28 is for a city (e.g., the exemplary template of FIG. 2B), the advertisement generation rules 14 may include an instruction that evaluates the weather (e.g., an instruction equivalent to the statement: “if tomorrow's expected precipitation in San Francisco is greater than 3 inches, then use ‘San Diego’ for the ‘city’ placeholder. Otherwise, use ‘San Francisco.’”)

The possible content for placeholders 28 can be specified within the advertising template 12 itself, or can be specified in another source. In some implementations, the possible content for placeholders 28 is stored on a data repository (not shown) with which the advertisement system 10 is in data communication. For instance, if possible content for a placeholder 28 includes a list of cities (San Diego, San Francisco, etc.), then the list of cities may be stored on the data repository, and retrieved by the advertisement system 10 based on the advertisement generation rules 14 and the particular values of the data (e.g., expected precipitation) used in evaluating the data.

The advertisement generation rules 14 can be specified by an advertiser or another party (e.g., a manufacturer, a party acting on behalf of an advertiser or manufacturer, etc.) or the system. In some implementations, the advertisement generation rules 14 are written to implement a marketing strategy of the advertiser.

The data source 18 provides data that may be relevant in applying the advertisement generation rules 14 to the advertisement template 12. For example, if one were to use the advertisement generation rules 14 described in the previous paragraph, the data source 18 may be used to store a local weather forecast for San Francisco. By way of further example, if one were to use the advertisement generation rules 14 that refer to the inventory of a product, the data source 18 may be used to store the product's current inventory.

In general, the data source 18 can include or access any type of information. This allows the advertiser a great deal of flexibility in designing an advertising campaign on the advertisement system 10. An advertiser can therefore implement an advertising campaign that produces different advertisements 20, based on any number of relevant pieces of information, for example: the outcome of a particular sports game, the winner of a particular reality television show, the number of patents issued in a given time frame, the headline of that day's Wall Street Journal, etc.

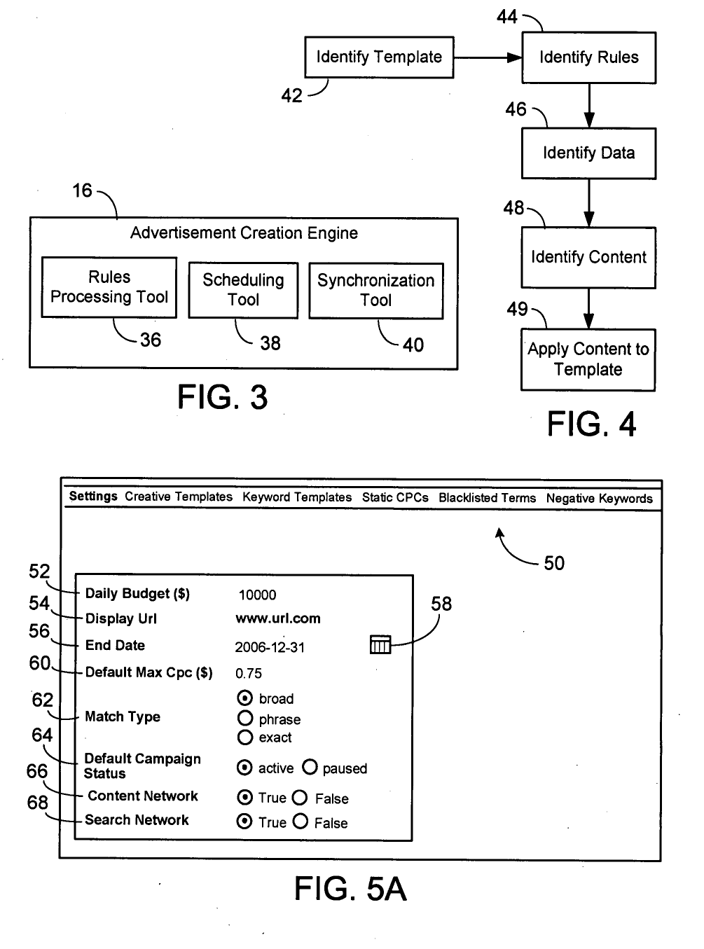

FIG. 3 is a schematic view of an exemplary advertisement creation engine 16. The exemplary advertisement creation engine 16 includes a rules processing tool 36, a scheduling tool 38, and a synchronization tool 40. In one implementation, each of these tools are in data communication with each other and the other components 12-18 of the advertisement system 10, either directly or indirectly via another component 12-18.

The rules processing tool 36 is operable to use the advertisement generation rules 14 to provide content for placeholders 28 in the advertisement template 12. In some implementations, this involves executing the advertisement generation rules 14, using the data source 18 to evaluate whether conditional instructions should be carried out, and creating, locating or identifying content for the placeholders 28 accordingly.

The rules processing tool 36 is also operable to combine the advertisement template 12 defined content with the placeholder content in order to form the advertisement 20. In some implementations, the advertisement 20 is expressed electronically, for example in HyperText Markup Language (HTML), Extensible Markup Language (XML), Really Simple Syndication/Rich Site Summary (RSS), etc.

The scheduling tool 38 is operable to cause the rules processing tool 36 to process the advertisement generation rules 14. In some implementations, the scheduling tool 38 causes the rules processing tool 36 to operate at a pre-determined time or periodically operate with a pre-determined period, for example, once per day. In some implementations, the scheduling tool 38 causes the rules processing tool 36 to operate when a pre-determined event occurs or a pre-determined condition exists. For example, the scheduling tool 38 can be used to manually cause the rules processing tool 36 to operate based on input from a user. Additionally, for example, the scheduling tool 38 can cause the rules processing tool 36 to operate based on the supply or demand of a product meeting a pre-defined criterion. In some implementations, the supply or demand information may be determined from the data source 18.

In some implementations, the scheduling tool 38 causes the rules processing tool 36 to operate based on a change in any of the advertisement template 12, the advertisement generation rules 14, or pre-defined data in the data source 18. For example, if the advertisement template 12 is updated to reflect a new advertising campaign, the scheduling tool 38 can cause the rules processing tool 36 to generate new advertisements 20.

The synchronization tool 40 is operable to organize advertisements 20 generated by the advertisement system 10. Organizing may include, for example, deleting old advertisements 20 or replacing old advertisements 20 with newly-generated advertisements 20. In some implementations, advertisements 20 are stored in an advertisement repository 21 in data communication with the synchronization tool 40. In some implementations, the data communication between the synchronization tool 40 and the advertisement repository 21 can be implemented using any application program interface (“API”).

FIG. 4 is a flowchart for creating an advertisement. To create an advertisement, an advertisement template is identified (step 42). In some implementations, the advertisement template 12 is identified by the rules processing engine 16. For example, the advertisement template 12 can be identified in response to input from a user, the occurrence of a pre-determined event, the existence of a pre-determined condition in the data source 18, etc.

Advertisement creation rules are identified (step 44). In some implementations, the advertisement generation rules 14 are identified by the rules processing engine 16. For example, the advertisement generation rules 14 can be identified in response to input from a user, the occurrence of a pre-determined event, the existence of a pre-determined condition in the data source 18, etc.

Data to be evaluated in accordance with the advertisement creation rules is also identified (step 46). In some implementations, this data is identified by the rules processing engine 16 from the data source 18. For example, the data can be identified based on a variable used in the advertisement generation rules 14 that corresponds to data in the data source 18.

The advertisement creation rules are evaluated using the identified data to identify content (step 48). In some implementations the rules processing engine 16 applies the advertisement generation rules 14 using data from the data source 18. For example, applying the advertisement creation rules can include parsing the advertisement generation rules 14 and determining the values of variables used in the rules.

Once the content is identified in step 48, the content is applied to the template (step 49). For example, the content can be inserted into placeholders 28 contained in the advertisement template 12. In some implementations, the rules processing engine 16 inserts the content into the placeholders 28 of an advertisement template 12.

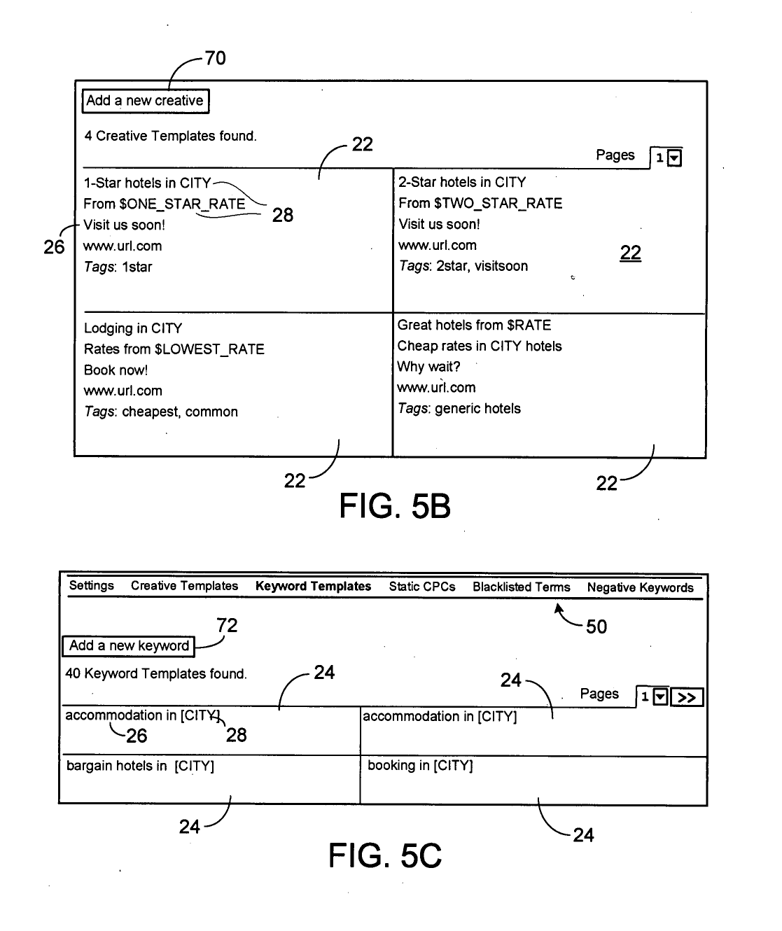

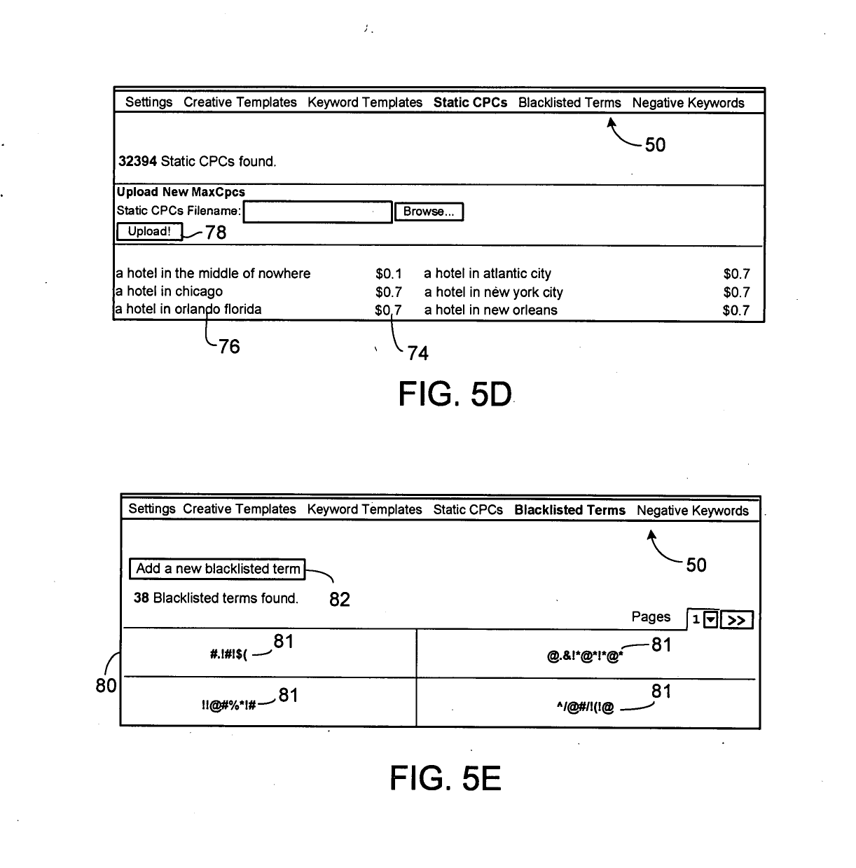

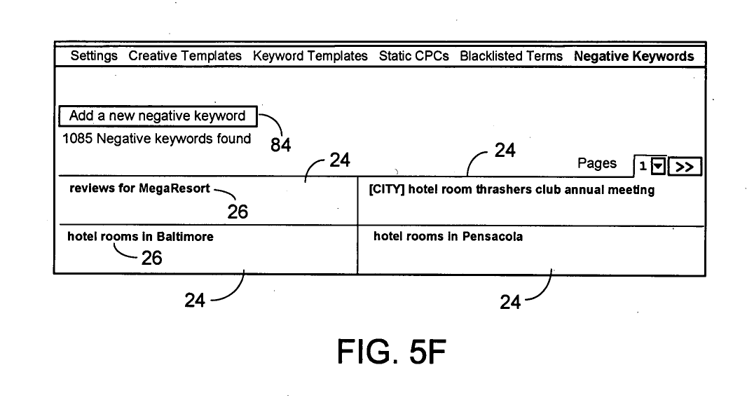

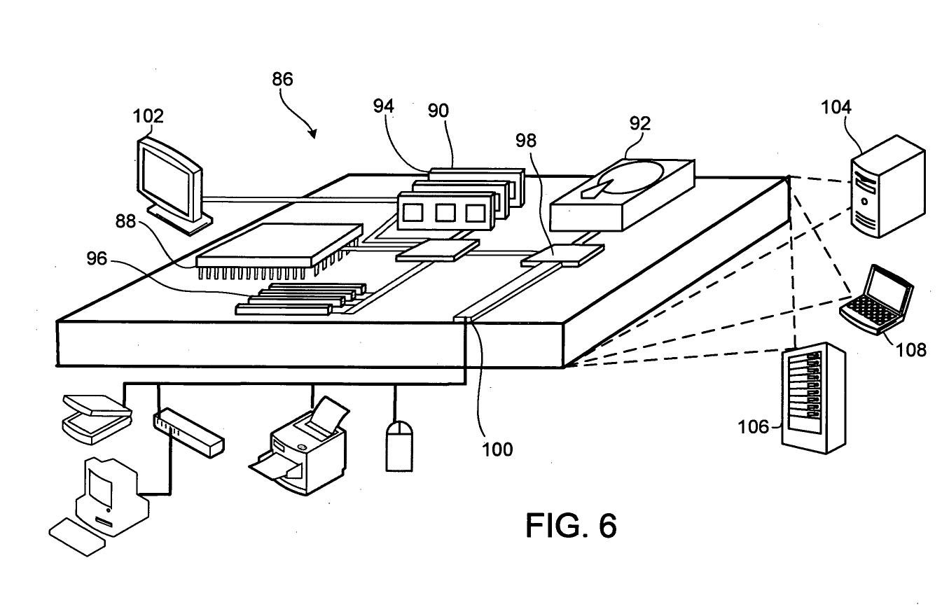

FIGS. 5A-F show exemplary screenshots for a user using the advertisement system 10. The user may include an advertiser using the advertisement system 10 to implement an advertising campaign. The user is presented with menus 50 allowing him/her to navigate between menus for: viewing and altering user settings, viewing or altering creative templates, viewing or altering keyword templates, adjusting static cost-per-click (“CPC”) settings, viewing or altering blacklisted terms, and viewing or altering negative keywords.

In the “settings” menu shown in FIG. 5A, the user can specify a budget 52 for a particular time period, e.g. a daily budget, for the advertising campaign. In some implementations, the advertisement system 10 monitors the total cost-to-date of implementing the advertising campaign, and will not generate or serve an advertisement 20 if doing so would exceed the user's budget 52.

In some implementations, the user can specify a uniform resource locator (URL) 54. This URL 54 will accompany advertisements 20 generated by the advertisement system 10. For example, the URL 54 may be incorporated into the creative content 34 of the advertisement 20, or may be displayed externally from the advertisement 20, in some pre-determined relative position (e.g., below).

In some implementations, the user can specify an end date 56 of the advertisement campaign. The advertisement system 10 no longer generates or displays advertisements 20 after the end date 56. The end date may be inputted using a calendar tool 58.

In some implementations, the user can specify a default maximum cost-per-click for the advertising campaign in a default maximum cost-per-click field 60. In interactive media (e.g., web pages), one way an advertiser can pay for advertisements 20 is on a “per click” basis—that is, the advertiser is charged each time an advertisement 20 is clicked on (i.e., selected). In some implementations, the cost-per-click of an advertisement 20 depends on the keyword 35 to which the advertisement 20 is responsive. A maximum cost-per-click may be specified individually for each of the keywords 35. In some implementations, if the advertiser specifies a default maximum cost-per-click for an advertising campaign 20, each keyword 35 of each advertisement 20 in the advertising campaign is treated as having this maximum cost-per-click, unless otherwise specified by the user.

In some implementations, the user can specify a match type, for controlling how often the advertisement is served (e.g., only on exact matches, etc.) The user can specify match types including “broad,” “phrase,” or “exact” (as described above) using the radio buttons 62.

In some implementations, the user can specify a default campaign status using default campaign status radio buttons 64. Default campaign statuses may include “active” or “paused.” An active campaign status results in advertisements 20 being generated by the advertisement system 10. A paused campaign status results in no advertisements 20 being served by the advertisement system 10. The default campaign status is the status with which newly-created advertisement campaigns are treated.

In some implementations, the user can specify various networks in which the advertisement system 10 will display advertisements 20. For example, the user can decide whether to display advertisements 20 in a content network or a search network by operating content network radio buttons 66 and search network radio buttons 68, respectively. Advertisements 20 are displayed in the content network based on the similarity of content (e.g., a news article) to one or more keywords 35 associated with a respective advertisement. Advertisements 20 are displayed in the search network based on the similarity of a search (e.g., a search query) provided by a user to keywords associated with the respective advertisements.

In FIG. 5B, the “creative templates” menu is shown. In some implementations, a user can add a creative template 22 by clicking on an “add new creative” button 70. In some implementations, a user may input the fixed component 26 in a creative template 22 in an input field, and delimit placeholders 28 using square brackets (i.e., [and ]).

In FIG. 5C, the “keyword templates” menu is shown. In some implementations, a user can add a keyword template 24 by clicking on an “add new keyword” button 72. In some implementations, a user may input the fixed component 26 in a keyword template 24 in an input field, and delimit placeholders similarly to FIG. 5B.

In FIG. 5D, the “static cost-per-click” menu is shown. In the static cost-per-click menu, a user may specify the maximum cost-per-click 74 the user is willing to pay for advertisements 20 served in response to the particular key words 76, as opposed to the default cost-per-click. In some implementations, the user may specify keywords 76 and corresponding cost-per-click maxima 74 from a pre-existing file, using an “upload” button 78. In some implementations, the user may specify keywords 76 and corresponding cost-per-click maxima 74 using a text entry field.

For the advertising campaign shown in FIG. 5D, the user is willing to pay $0.70 per click on advertisements 20 served in response to keywords describing five United States cities. The user is also willing to pay $.10 per click on advertisements 20 served in response to the keywords “a hotel in the middle of nowhere.” The ability to specify individual cost-per-click constraints helps an advertiser efficiently implement the advertising campaign.

In some implementations, an advertiser may create a cost-per-click differential between different keywords based on the advertiser's strategy. For example, in FIG. 5B, the advertiser's strategy may be based on the hypothesis that advertisements 20 responsive to “a hotel in the middle of nowhere” will generate one-seventh the business that the other advertisements 20 will generate.

In FIG. 5E, the “blacklisted terms” menu is shown. In some implementations, a user can associate a blacklisted term 81 with an advertisement template 12 using the “add a new blacklisted term” button 82.

A blacklisted term 81 is a term that will be prevented from appearing in an advertisement 20. For example, if the advertiser, publisher, or other party regards certain terms as scandalous, profane, or otherwise does not want those terms appearing in the advertisement 20 for any reason, those terms may be included among the blacklisted terms. In FIG. 5E, for example, four blacklisted terms 81 are shown.

In FIG. 5F, the “negative keywords” menu is shown. In some implementations, a user can add a negative keyword in the keyword template 24 by clicking on an “add new negative keyword” button 84. In some implementations, a user may input the fixed component 26 in a keyword template 24 in an input field, and delimit placeholders 28 using square brackets, similarly to FIG. 5B.

An advertiser may wish to include negative keywords in an advertisement to streamline the advertising campaign. For example, in FIG. 5B, the “reviews for MegaResort” negative keyword can be used to prevent advertisements for MegaResort from appearing on pages containing reviews for MegaResort. An advertiser may consider a review to be equivalent to an advertisement, and therefore may consider advertising on such pages as inefficient.

In another example, an advertiser may wish to exclude a certain audience from its target audience. In FIG. 5F, using the “Texas hotel room thrashers club annual meeting” negative keyword may be used to prevent advertisements for hotel rooms from being displayed to a particular group.

In yet another example, negative keywords may also be used to control the context in which the advertisement 20 appears. For example, if an advertiser does not want advertisements 20 to appear in contexts involving particular competitors, negative keywords may be used to help prevent this from occurring. In FIG. 5F, for example, the negative keyword “hotel rooms at MegaCompetitor” can prevent advertisements 20 from being served in the context of MegaCompetitor.

Similarly, if an advertiser is promoting several products or services associated with a common phrase, negative keywords can be used to help the efficiency of the advertising campaign. For example, if the hotel MegaResort also manufactures a line of sunglasses, then including “MegaResort brand sunglasses” among the negative keywords can help prevent MegaResort hotel advertisements from being served in the context of MegaResort sunglasses, if desired by the advertiser.

FIG. 6 is a block diagram of a computing device 86 that may be used to implement the advertisement system 10, as either a client or as a server or plurality of servers. Computing device 86 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document. Though reference is made to a computing device, the advertisement system described can be implemented in whole or part on other electronic devices that are not classically computers (e.g., cellular telephones, set top boxes, and other electronic devices).

Computing device 86 includes a processor 88, memory 90, a storage device 92, a high-speed interface 94 connecting to memory 90 and high-speed expansion ports 96, and a low speed interface 98 connecting to low speed bus 100 and storage device 92. Each of the components 88, 90, 92, 94, 96, 98, are interconnected using various busses, and may be mounted on a common motherboard or in other manners as appropriate. The processor 88 can process instructions for execution within the computing device 86, including but not limited to instructions stored in the memory 90 or on the storage device 92 to display graphical information for a GUI on an external input/output device, such as display 102 coupled to high-speed interface 94. In other implementations, multiple processors and/or multiple buses may be used, as appropriate, along with multiple memories and types of memory. Also, multiple computing devices 86 may be connected, with each device providing portions of the necessary operations (e.g., as a server bank, a group of blade servers, or a multi-processor system).

The memory 90 stores information within the computing device 86. In one implementation, the memory 90 is a computer-readable medium. In one implementation, the memory 90 is a volatile memory unit or units. In another implementation, the memory 90 is a non-volatile memory unit or units.

The storage device 92 is capable of providing mass storage for the computing device 86. In one implementation, the storage device 92 is a computer-readable medium. In various different implementations, the storage device 92 may be a floppy disk device, a hard disk device, an optical disk device, or a tape device, a flash memory or other similar solid state memory device, or an array of devices, including but not limited to devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 90, the storage device 92, memory on processor 88, or a propagated signal.

The high-speed interface 94 manages bandwidth-intensive operations for the computing device 86, while the low speed interface 98 manages lower bandwidth-intensive operations. Such allocation of duties is exemplary only. In one implementation, the high-speed interface 94 is coupled to memory 90, display 102 (e.g., through a graphics processor or accelerator), and to high-speed expansion ports 96, which may accept various expansion cards (not shown). In the implementation, low speed interface 98 is coupled to storage device 92 and low speed bus 100. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 86 may be implemented in a number of different forms, as shown in the figure. For example, it may be implemented as a standard server 130, or multiple times in a group of such servers. It may also be implemented as part of a rack server system 106. In addition, it may be implemented in a personal computer such as a laptop computer 108.

Various implementations of the advertisement system 10 can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including but not limited to at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including but not limited to a machine-readable medium that receives machine instructions as a machine-readable signal. The term “machine-readable signal” refers to any signal used to provide machine instructions and/or data to a programmable processor.

To provide for interaction with a user, the advertisement system 10 can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including but not limited to acoustic, speech, or tactile input.

The advertisement system 10 can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the advertisement system 10), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other embodiments are within the scope of the following claims.

1. A method performed by data processing apparatus comprising one or more processors, the method comprising:
identifying, by the one or more processors, an advertisement template, the advertisement template including a fixed portion and a placeholder, the placeholder being a portion of the advertisement template in which advertiser specific content is selectively definable, the fixed portion of the advertisement template including pre-defined text, wherein the advertisement template is associated with a product or service;
identifying, by the one or more processors, a condition for selection of advertiser specific content for the placeholder, wherein the condition includes whether a current value associated with a varying attribute of the product or service is within an advertiser specified range of values;
selecting advertiser specific content for presentation in the placeholder based on the condition, including selecting a first advertiser specific content for presentation in the placeholder when the current value associated with the varying attribute of the product or service is within the advertiser specified range of values and selecting a second advertiser specific content for presentation in the placeholder when the current value associated with the varying attribute of the product or service is outside the advertiser specified range of values;
creating, by the one or more processors, an advertisement using the advertisement template, the advertisement including the fixed portion and the selected advertiser specific content in the placeholder;
determining, by the one or more processors using the fixed portion of the advertisement template, that the advertisement is to be served in response to a query when a word or phrase appearing in the query matches the pre-defined text in the fixed portion of the advertisement template; and
serving, by the one or more processors, the created advertisement.

2. The method of claim 1, wherein the advertisement template includes a creative template corresponding to a portion of the advertisement that is directly perceivable by a viewer.

3. The method of claim 35, wherein the advertisement template includes a keyword template corresponding to the one or more keywords.

4-12. (canceled)

13. The method of claim 3, wherein the advertisement includes the one or more keywords determined from the keyword template, each of the keywords having a match type.

14. The method of claim 13, wherein each match type is one of:
specific, general, phrase, and negative.

15. The method of claim 14, wherein a first keyword has a first match type, and a second keyword has a second match type, the first keyword being distinct from the second keyword, and the first match type being distinct from the second match type.

16. The method of claim 13, comprising identifying a maximum advertising cost associated with each keyword.

17. The method of claim 1, comprising identifying a set of blacklisted terms, and determining whether the content includes a term in the set of blacklisted terms.

18. A system, comprising:
a processor;
a rules processing tool that is configured to perform operations including:
identifying, at a first time, an advertisement template, the advertising template including a fixed portion and a placeholder, the placeholder being a portion of the advertisement in which advertiser specific content is selectively definable, the fixed portion of the advertisement template including pre-defined text;
identifying, at the first time, a condition for selection of advertiser specific content for the placeholder, wherein the condition includes whether a current value at a time for display after the first time of a varying context characteristic of the advertisement template is within an advertiser specified range of values;
dynamically selecting, at the time for display after the first time, advertiser specific content for presentation in the placeholder specified in accordance with the current value of the varying context characteristic of the advertisement template at the time for display based on the condition, including selecting a first advertiser specific content for presentation in the placeholder when the current value of the varying context characteristic of the advertisement template is within the advertiser specified range of values and selecting a second advertiser specific content for presentation in the placeholder when the current value associated with the varying context characteristic is outside the advertiser specified range of values;
creating an advertisement using the advertisement template, the advertisement including the fixed portion and the selected advertiser specific content in the placeholder;
a synchronization tool that is configured to perform operations including serving the created advertisement in response to a query at the time for display when a word or phrase appearing in the query matches the pre-defined text in the fixed portion of the advertisement template.

19. The system of claim 18, wherein the rules processing tool is configured to perform operations including identifying a creative template corresponding to a portion of the advertisement that is directly perceivable by a viewer.

20. (canceled)

21. (canceled)

22. The system of claim 36, the operations comprising:
identifying a match type for each of the one or more keywords,
wherein the advertisement includes the one or more keywords determined from a keyword template, each of the keywords having a match type.

23. The system of claim 22, the operations comprising identifying a maximum advertising cost associated with each keyword.

24. A non-transitory computer-readable medium bearing instructions that, when executed, cause a computer to perform operations comprising:
identifying an advertising template, the advertising template including a fixed portion and a placeholder, the placeholder being a portion of the advertisement in which advertiser specific content is selectively definable, the fixed portion of the advertisement template including pre-defined text, wherein the advertising template is associated with an event having a plurality of possible outcomes;
identifying a condition for selection of advertiser specific content for the placeholder, wherein the condition includes whether an actual outcome of the event corresponds to an advertiser specified outcome for the event;
selecting advertiser specific content for presentation in the placeholder based on the condition, including selecting a first advertiser specific content for presentation in the placeholder when the actual outcome of the event corresponds to the advertiser specified outcome for the event and selecting a second advertiser specific content for presentation in the placeholder when the actual outcome of the event does not correspond to the advertiser specified outcome for the event;
creating an advertisement using the advertisement template, the advertisement including the fixed portion and the advertiser specific content in the placeholder;
determining, using the fixed portion of the advertisement template, that the advertisement is to be served in response to a query when a word or phrase appearing in the query matches the pre-defined text in the fixed portion of the advertisement template; and
serving the created advertisement.

25. The computer-readable medium of claim 24, wherein the advertisement template includes a creative template corresponding to a portion of the advertisement that is directly perceivable by a viewer.

26. (canceled)

27. (canceled)

28. The computer-readable medium of claim 37, the operations comprising identifying a maximum advertising cost associated with each of the one or more keywords.

29. A system, comprising:
a first non-transitory data storage device storing an advertisement template, the advertising template including a fixed portion and a placeholder, the placeholder being a portion of the advertisement template in which advertiser specific content is selectively definable, the fixed portion of the advertisement template including pre-defined text, wherein the advertisement template is associated with a product;
a second non-transitory data storage device storing a condition specifying advertiser specific content to select for the placeholder when the condition is satisfied;
a third non-transitory data storage device storing advertiser specific content that are selectable for presentation in the placeholder;
a fourth non-transitory data storage device storing product data including a value associated with a varying attribute of the product; and
a processor operable to perform operations comprising:
determining that the value associated with the varying attribute of the product has changed from a first value that is outside an advertiser specified range of values for the attribute of the product to a second value that is within the advertiser specified range of values for the attribute of the product;
in response to determining that the value associated with the varying attribute of the product has changed from the first value to the second value, selecting advertiser specific content associated with the second value for the placeholder in accordance with the condition, the advertiser specific content associated with the second value being different from advertiser specific content associated with the first value;
creating an advertisement using the advertisement template, the advertisement including the fixed portion and the selected advertiser specific content in the placeholder;
determining, using the fixed portion of the advertisement template, that the advertisement is to be served in response to a query when a word or phrase appearing in the query matches the pre-defined text in the fixed portion of the advertisement template; and
serving the created advertisement.

30. The system of claim 29, wherein the advertisement template includes a creative template corresponding to a portion of the advertisement that is directly perceivable by a viewer.

31. The system of claim 36, wherein the advertisement template includes a keyword template corresponding to the one or more keywords of the advertisement for use when comparing the advertisement to other content.

32-34. (canceled)

35. A method performed by data processing apparatus comprising one or more processors, the method comprising:
identifying, by the one or more processors, an advertisement template, the advertisement template including a fixed portion, a first placeholder, and a second placeholder, the first and second placeholder each being a portion of the advertisement template in which advertiser specific content is selectively definable, the fixed portion of the advertisement template being operable to generate one or more keywords;
identifying, by the one or more processors, a condition for selection of advertiser specific content for the first placeholder, and content for the second placeholder based on the advertiser specific content for the first placeholder;
determining whether data external to the advertisement template satisfies the condition for selection of advertiser specific content for the first placeholder;
selecting advertiser specific content for presentation (i) in the first placeholder based on the condition, and (ii) in the second placeholder based, at least in part, on the advertiser specific content of the first placeholder, including selecting a first advertiser specific content for presentation in the first placeholder when the condition is satisfied and selecting a second, different advertiser specific content for presentation in the first placeholder when the condition is not satisfied;
creating, by the one or more processors, an advertisement using the advertisement template, the advertisement including the one or more keywords and the selected advertiser specific content in the first and second placeholders;
determining, by the one or more processors using the fixed portion of the advertisement template, that the advertisement is to be served in response to a query when a word or phrase appearing in the query matches at least one of the one or more keywords generated based on the fixed portion of the advertisement template; and
serving, by the one or more processors, the created advertisement.

36. A system, comprising:
one or more processors configured to perform operations comprising:
identifying an advertisement template, the advertisement template including a fixed portion, a first placeholder, and a second placeholder, the first and second placeholder each being a portion of the advertisement template in which advertiser specific content is selectively definable, the fixed portion of the advertisement template being operable to generate one or more keywords;
identifying a condition for selection of advertiser specific content for the first placeholder, and content for the second placeholder based on the advertiser specific content for the first placeholder;
determining whether data external to the advertisement template has changed from a first value that does not satisfy the condition for selection of advertiser specific content for the first placeholder to a second value that does satisfy the condition for selection of advertiser specific content for the first placeholder;
in response to determining that the data has changed from the first value to the second value, selecting advertiser specific content associated with the second value for presentation (i) in the first placeholder based on the condition, and (ii) in the second placeholder based, at least in part, on the advertiser specific content of the first placeholder, wherein the advertiser specific content associated with the second value is different from advertiser specific content associated with the first value; and
creating an advertisement using the advertisement template, the advertisement including the one or more keywords and the advertiser specific content in the first and second placeholders;
determining, using the fixed portion of the advertisement template, that the advertisement is to be served in response to a query when a word or phrase appearing in the query matches at least one of the one or more keywords generated based on the fixed portion of the advertisement template; and
serving the created advertisement.

37. A non-transitory computer-readable medium bearing instructions that, when executed, cause a computer to perform operations comprising:
identifying an advertisement template, the advertisement template including a fixed portion, a first placeholder, and a second placeholder, the first and second placeholder each being a portion of the advertisement template in which advertiser specific content is selectively definable, the fixed portion of the advertisement template being operable to generate one or more keywords;
identifying a condition for selection of advertiser specific content for the first placeholder, and content for the second placeholder based on the advertiser specific content for the first placeholder;
determining, using the fixed portion of the advertisement template, that an advertisement is to be served in response to a query when a word or phrase appearing in the query matches at least one of the one or more keywords generated based on the fixed portion of the advertisement template;
in response to determining that the advertisement is to be served in response to the query, selecting the advertiser specific content for presentation (i) in the first placeholder based on the condition for selection, and (ii) in the second placeholder based, at least in part, on the advertiser specific content selected for presentation in the first placeholder, including selecting a first advertiser specific content for presentation in the first placeholder when the condition is satisfied and selecting a second, different advertiser specific content for presentation in the first placeholder when the condition is not satisfied;
creating the advertisement using the advertisement template, the advertisement including the one or more keywords and the selected advertiser specific content in the first and second placeholders;
serving the created advertisement.

38. The method of claim 1, wherein the current value associated with the varying attribute of the product or service comprises a current value indicating a supply or demand of the product or service, and selecting the advertiser specific content for presentation in the placeholder based on the condition comprises:
selecting a first price associated with the product for presentation in the placeholder when the current value indicating the supply or demand of the product or service is within the advertiser specified range of values; and
selecting a second, different price associated with the product for presentation in the placeholder when the current value indicating the supply or demand of the product or service is outside the advertiser specified range of values.

39. The system of claim 18, wherein the current value of the varying context characteristic comprises a current value associated with a weather forecast in a geographic location associated with the advertisement template, and the rules processing tool performs operations comprising:
selecting a name of a first geographic location for presentation in the placeholder when the current value associated with the weather forecast of the geographic location is within the advertiser specified range of values; and
selecting a name of a second, different geographic location for presentation in the placeholder when the current value associated with the weather forecast of the geographic location is outside the advertiser specified range of values.

40. The non-transitory computer-readable medium of claim 24, wherein the event having a plurality of possible outcomes comprises an event having a plurality of possible winners, the actual outcome of the event comprises an actual winner of the event, and selecting the advertiser specific content for presentation in the placeholder based on the condition comprise:
selecting the first advertiser specific content for presentation in the placeholder when the actual winner of the event corresponds to an advertiser specified winner; and
selecting the second advertiser specific content for presentation in the placeholder when the actual winner of the event does not correspond to the advertiser specified winner.

41. The system of claim 29, wherein the value associated with the varying attribute of the product comprises a value indicating a supply or demand of the product, and selecting the advertiser specific content associated with the second value comprises selecting a price associated with the second value.
